(19) United States
(12) Patent Application Publication
(10) Pub. No.: US 2026/0094745 A1
(43) Pub. Date: Apr. 2, 2026

(54) Magnetorheological Fluid And Braking Device

(71) Applicant: SEIKO EPSON CORPORATION, Tokyo (JP)

(72) Inventors: Daisuke ISHIHARA, Matsumoto (JP); Takeshi YANO, Fujimi (JP); Shigeki KAWADA, Shiojiri (JP)

(21) Appl. No.: 19/341,001

(22) Filed: Sep. 26, 2025

(30) Foreign Application Priority Data
Sep. 27, 2024 (JP) 2024-168304

(51) Int. Cl. H01F 1/44; B22F 1/052; B22F 1/054; B22F 1/107; B60T 1/08; B60T 10/00; C22C 45/02; F16D 57/00

(52) U.S. Cl. CPC H01F 1/447; B22F 1/052; B22F 1/054; B22F 1/107; B60T 1/08; B60T 10/00; C22C 45/02; F16D 57/002; B22F 2301/35; B22F 2304/054; B22F 2304/10; B22F 2999/00; C22C 2200/02; F16D 2200/0034

(57) ABSTRACT

A magnetorheological fluid includes: a first metal magnetic particle having an average particle diameter of 5 μm or more; a second metal magnetic particle having an average particle diameter of 500 nm or less; and an ionic liquid having a cationic group and an anionic group, in which the cationic group is one or more selected from the group including a quaternary ammonium ion, an imidazolium ion, a pyridinium ion, and a phosphonium ion, and the anionic group is one or more selected from the group including a tetrafluoroborate ion, a hexafluorophosphate ion, a trispentafluoroethyl trifluorophosphate ion, and a bis(trifluoromethanesulfonyl)amide ion.

The present application is based on, and claims priority from JP Application Serial Number 2024-168304, filed Sep. 27, 2024, the disclosure of which is hereby incorporated by reference herein in its entirety.

### BACKGROUND

### 1. Technical Field

The present disclosure relates to a magnetorheological fluid and a braking device.

### 2. Related Art

The magnetorheological fluid (an MR fluid) is a fluid obtained by dispersing magnetic particles in a dispersion medium such as mineral oil or silicone oil. When a magnetic field is applied to the magnetorheological fluid, metal magnetic particles are magnetized and aligned in a magnetic field direction, thereby forming a chain cluster. Accordingly, the viscosity of the magnetorheological fluid increases, and the yield stress increases.

The use of such a magnetorheological fluid in various fields such as a control device such as a damper and a braking device such as a brake and a clutch has been studied.

In these applications, a range from minus several tens ° C. to several hundred ° C. is assumed as a temperature range in which the magnetorheological fluid is used. Therefore, the magnetorheological fluid is required to maintain physical properties not only at room temperature but also at low and high temperatures.

For example, JP-T-2010-504635 discloses that it is assumed that a magnetorheological fluid is used at a high temperature of 200° C., and an ionic liquid is used as a dispersion medium as a solution to prevent evaporation of the magnetorheological fluid.

JP-T-2010-504635 is an example of the related art.

From a viewpoint of further expanding the use range of the magnetorheological fluid, it is required to prevent aggregation and sedimentation of the magnetic particles and to exhibit high excitation stress while ensuring high reliability even when used at low and high temperatures.

### SUMMARY

A magnetorheological fluid according to an application example of the present disclosure includes:
a first metal magnetic particle having an average particle diameter of 5 μm or more;
a second metal magnetic particle having an average particle diameter of 500 nm or less; and
an ionic liquid having a cationic group and an anionic group, in which
the cationic group is one or more selected from the group including a quaternary ammonium ion, an imidazolium ion, a pyridinium ion, and a phosphonium ion, and
the anionic group is one or more selected from the group including a tetrafluoroborate ion, a hexafluorophosphate ion, a trispentafluoroethyl trifluorophosphate ion, and a bis(trifluoromethanesulfonyl)amide ion.

A braking device according to an application example of the present disclosure includes:
a fixed portion;
a movable portion movable with respect to the fixed portion;
the magnetorheological fluid according to an application example of the present disclosure held between the fixed portion and the movable portion; and
a magnetic field generation unit configured to apply a magnetic field to the magnetorheological fluid.

### BRIEF DESCRIPTION OF THE DRAWINGS

FIG. 1 is a schematic diagram illustrating a magnetorheological fluid according to an embodiment.

FIG. 2 is a longitudinal cross-sectional view illustrating a braking device according to the embodiment.

FIG. 3 illustrates Table 1 indicating preparation conditions and evaluation results of the magnetorheological fluid.

FIG. 4 illustrates Table 2 indicating preparation conditions and evaluation results of the magnetorheological fluid.

FIG. 5 illustrates Table 3 indicating preparation conditions and evaluation results of the magnetorheological fluid.

FIG. 6 illustrates Table 4 indicating preparation conditions and evaluation results of the magnetorheological fluid.

FIG. 7 illustrates Table 5 indicating preparation conditions and evaluation results of the magnetorheological fluid.

FIG. 8 illustrates Table 6 indicating preparation conditions and evaluation results of the magnetorheological fluid.

FIG. 9 illustrates Table 7 indicating preparation conditions and evaluation results of the magnetorheological fluid.

FIG. 10 illustrates Table 8 indicating preparation conditions and evaluation results of the magnetorheological fluid.

FIG. 11 illustrates Table 9 indicating preparation conditions and evaluation results of the magnetorheological fluid.

### DESCRIPTION OF EMBODIMENTS

Hereinafter, a magnetorheological fluid and a braking device according to the present disclosure will be described in detail based on an embodiment illustrated in the accompanying drawings.

### 1. Magnetorheological Fluid

First, a magnetorheological fluid according to an embodiment will be described.

The magnetorheological fluid is a fluid that behaves like a liquid when no magnetic field is applied and like a semi-solid when a magnetic field is applied. The stress of the magnetorheological fluid can be controlled by utilizing such a change in viscosity. Therefore, the magnetorheological fluid can be used in various devices that exhibit various functions by utilizing a change in stress.

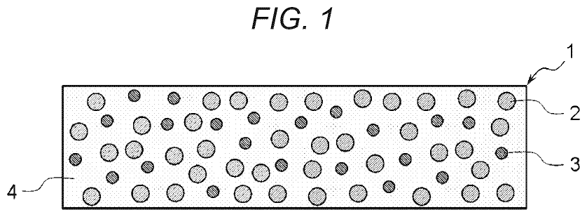

FIG. 1 is a schematic diagram illustrating a magnetorheological fluid 1 according to the embodiment. The magnetorheological fluid 1 illustrated in FIG. 1 includes first metal magnetic particles 2, second metal magnetic particles 3, and an ionic liquid 4. Each of the first metal magnetic particle 2 and the second metal magnetic particle 3 is a dispersoid. The ionic liquid 4 is a dispersion medium.

The first metal magnetic particle 2 has an average particle diameter d1 of 5 μm or more. In contrast, the second metal magnetic particle 3 has an average particle diameter d2 of 500 nm or less.

The ionic liquid 4 has a cationic group and an anionic group.

The cationic group is one or more selected from the group including a quaternary ammonium ion, an imidazolium ion, a pyridinium ion, and a phosphonium ion.

The anionic group is one or more selected from the group including a tetrafluoroborate ion, a hexafluorophosphate ion, a trispentafluoroethyl trifluorophosphate ion, and a bis(trifluoromethanesulfonyl)amide ion.

According to such a configuration, by including the two types of dispersoids (the first metal magnetic particle 2 and the second metal magnetic particle 3) having different average particle diameters, the lifting effect is obtained in which the relatively small second metal magnetic particles 3 promote the dispersion of the relatively large first metal magnetic particles 2. Accordingly, a satisfactory dispersed state of the dispersoid can be maintained. As a result, since sedimentation of the dispersoid can be prevented, a decrease in excitation stress can be prevented. By using the ionic liquid 4 as the dispersion medium, satisfactory affinity with the dispersoid can be maintained even at a low temperature or a high temperature. That is, the ionic liquid 4 having the cationic group and the anionic group as described above is still a liquid even at a low temperature of 0° C. or lower and is less likely to evaporate even at a high temperature of 250° C. or higher, and thus is a dispersion medium having high reliability. The ionic liquid 4 has affinity with the first metal magnetic particles 2 and the second metal magnetic particles 3 higher than that in the mineral oil. Therefore, by using the ionic liquid 4 as the dispersion medium, separation between the dispersoid and the dispersion medium is less likely to occur even at a low temperature or a high temperature. As a result, the magnetorheological fluid 1 that maintains a satisfactory dispersed state of the dispersoids and exhibits high excitation stress regardless of the environment can be achieved.

### 1.1. Dispersoid

The dispersoid of the magnetorheological fluid 1 includes the first metal magnetic particles 2 and the second metal magnetic particles 3.

Examples of a material forming the first metal magnetic particle 2 and a material forming the second metal magnetic particle 3 include metal-based magnetic materials such as a Fe-based metal material, a Ni-based metal material, and a Co-based metal material, and one or a composite material of two or more types of these materials is used. A composite material of the metal-based magnetic material and an oxide-based magnetic material may be used. Among these materials, a Fe-based metal material is preferably used as the material forming the first metal magnetic particle 2 from the viewpoint of high saturation magnetization.

The Fe-based metal material is a metal material containing Fe as a main component. The main component means that a content of Fe in the Fe-based metal material is 50% or more in terms of atomic ratio. Such a Fe-based metal material has saturation magnetization, toughness, and strength higher than those of ferrite. Therefore, the Fe-based metal material is useful as each of the materials forming the first metal magnetic particle 2 and the second metal magnetic particle 3.

In addition to Fe, the Fe-based metal material may contain an element that exhibits ferromagnetic properties alone, such as Ni or Co, and may contain at least one selected from the group including Cr, Nb, Cu, Al, Mn, Mo, Si, Sn, B, C, P, Ti, and Zr according to target properties. The Fe-based metal material may contain inevitable impurities as long as the effects of the embodiment are not impaired. The inevitable impurities are impurities unintentionally mixed in raw materials or during production. Examples of the inevitable impurities include all elements other than the above-described elements, and in particular, are O, N, S, Na, Mg, and K.

Such a Fe-based metal material is not particularly limited, and examples thereof include, in addition to pure iron and carbonyl iron, Fe-based alloy materials such as a Fe—Si—Al-based alloy such as Sendust, Fe—Ni based, Fe—Co based, Fe—Ni—Co based, Fe—Si—B based, Fe—Si—Cr—B based, Fe—Si—B—C based, Fe—Si—B—Cr—C based, Fe—Si—Cr based, Fe—B based, Fe—P—C based, Fe—Co—Si—B based, Fe—Si—B—Nb based, Fe—Si—B—Nb—Cu based, Fe—Zr—B based, Fe—Cr based, and Fe—Cr—Al based alloys.

Each of the materials forming the first metal magnetic particle 2 and the second metal magnetic particle 3 may be an amorphous metal material, a crystalline metal material, or a microcrystalline (nanocrystal) metal material. Among these materials, at least one of the materials forming the first metal magnetic particle 2 and the second metal magnetic particle 3 is preferably an amorphous metal material or a microcrystalline metal material. These materials contribute to sufficient lowering of the coercive force of the first metal magnetic particle 2 and the second metal magnetic particle 3 and enhancement of the redispersibility. These materials have toughness and strength higher than, for example, those of metal oxides. Therefore, the first metal magnetic particle 2 and the second metal magnetic particle 3 can be effectively prevented from being worn or damaged. As a result, the magnetorheological fluid 1 having a stable excitation stress can be achieved. Since the amorphous metal material and the microcrystalline metal material do not have crystal grain boundaries or are minute, corrosion originating from the crystal grain boundaries is less likely to occur. Therefore, corrosion resistance of the first metal magnetic particle 2 and the second metal magnetic particle 3 is particularly enhanced. The microcrystalline metal material refers to a metal material in which microcrystalline crystals (nanocrystals) having a crystal grain size of 100 nm or less are present.

Examples of the amorphous metal material include binary or multi-element Fe-based amorphous alloys such as Fe—Si—B based, Fe—Si—Cr—B based, Fe—Si—B—C based, Fe—Si—B—Cr—C based, Fe—Si—Cr based, Fe—B based, Fe—B—C based, Fe—P—C based, Fe—Co—Si—B based, Fe—Si—B—Nb based, and Fe—Zr—B based alloys, a Ni-based amorphous alloy such as Ni—Si—B based and Ni—P—B based alloys, and a Co-based amorphous alloy such as a Co—Si—B based alloy.

Examples of the microcrystalline metal material include Fe-based nanocrystal alloys such as Fe—Si—B—Nb—Cu based, Fe—Zr—B based, Fe—Hf—B based, Fe—Nb—B based, Fe—Zr—B—Co based, Fe—Hf—B—Co based, Fe—Nb—B—Co based, and Fe—Si—B—P—Cu based alloys.

The first metal magnetic particle 2 and the second metal magnetic particle 3 may each be a particle produced by any method. Examples of the production method include various atomization methods such as a water atomization method, a gas atomization method, and a rotating water flow atomization method, a pulverization method, and a carbonyl method. Among these methods, the atomization method can produce main bodies whose particle shapes are closer to perfect spheres. Such particles are less likely to aggregate.

The material forming the first metal magnetic particle 2 and the material forming the second metal magnetic particle 3 may be the same or different from each other.

The first metal magnetic particle 2 and the second metal magnetic particle 3 may each include an oxide film provided on a surface of the particle body made of the metal-based magnetic material as described above. The oxide film is interposed between the particle body and a surface modification film to be described later, and enhances adhesion of the surface modification film to the particle body. The oxide film can protect the particle body, prevent aggregation, and improve moisture resistance and rust resistance of the particle body. The oxide film preferably covers the entire surface of the particle body, but may be provided only on a part of the surface.

Examples of materials forming the oxide film include a silicon oxide, an aluminum oxide, a titanium oxide, a vanadium oxide, a niobium oxide, a chromium oxide, a manganese oxide, a tin oxide, and a zinc oxide, and one or a mixture or a composite of two or more of these materials may be used.

Among these materials, the silicon oxide is preferably used. The silicon oxide is an oxide represented by a composition formula SiOₓ (0<x≤2), and is preferably SiO₂.

The surface modification film covers the surface of the particle body via the oxide film. Accordingly, the dispersibility of the first metal magnetic particles 2 and the second metal magnetic particles 3 in the ionic liquid 4 can be enhanced. The surface modification film preferably covers the entire oxide film or the entire surface of the particle body, but may be provided only on a part of the surface.

A material forming the surface modification film includes a coupling agent, a surfactant, or an organic compound derived from a polymer polymerized film. The coupling agent is a compound having a functional group and a hydrolyzable group. By using the coupling agent, the functional group can be introduced into the surface of the oxide film or the surface of the particle body. Accordingly, aggregation of the particles of the dispersoid can be prevented, and dispersibility in the ionic liquid 4 can be further enhanced. Accordingly, the dispersoid which is excellent in followability to a change in magnetic field and can be uniformly dispersed even at a high concentration in the ionic liquid 4 can be achieved.

The surface modification film also contributes to enhancement of moisture resistance, rust resistance, and the like of the dispersoid. Deterioration caused by moisture absorption or rust generation of the dispersoid can be prevented by enhancing the moisture resistance and the rust resistance.

Examples of the functional group provided in the coupling agent include an aliphatic hydrocarbon group, a cyclic structure-containing group, a fluoroalkyl group, a fluoroaryl group, a nitro group, an acyl group, and a cyano group. In particular, an aliphatic hydrocarbon group or a cyclic structure-containing group is preferably used.

The average particle diameter d1 of the first metal magnetic particle 2 is 5 μm or more as described above, but is preferably 6 μm or more and 15 μm or less, and more preferably 7 μm or more and 10 μm or less. When the average particle diameter d1 of the first metal magnetic particle 2 is within the above ranges, the magnetic field responsiveness of the first metal magnetic particle 2 can be sufficiently increased. Accordingly, the excitation stress of the magnetorheological fluid 1 can be increased. When the average particle diameter d1 of the first metal magnetic particle 2 is below the above lower limit value, the magnetic field responsiveness of the first metal magnetic particle 2 decreases, and therefore the excitation stress of the magnetorheological fluid 1 decreases. In contrast, when the average particle diameter d1 of the first metal magnetic particle 2 exceeds the upper limit value, the first metal magnetic particles 2 may easily settle even when there is a lifting effect by the second metal magnetic particles 3. When the first metal magnetic particle 2 settles, a necessary excitation stress may not be obtained.

The average particle diameter d2 of the second metal magnetic particle 3 is 500 nm or less as described above, but is preferably 10 nm or more and 150 nm or less, and more preferably 15 nm or more and 50 nm or less. When the average particle diameter d2 of the second metal magnetic particle 3 is within the above ranges, a lifting effect by Brownian motion of the second metal magnetic particle 3 can be sufficiently obtained. That is, the second metal magnetic particle 3 undergoing Brownian motion generates a diffusion force larger than a sedimentation force caused by gravity, floats, and also contributes to prevention of the sedimentation of the first metal magnetic particle 2. In the present specification, such an effect is referred to as a lifting effect. Due to the lifting effect by the second metal magnetic particles 3, a satisfactory dispersed state of the dispersoid can be maintained. The second metal magnetic particle 3 is magnetic despite its small size, which contributes to an increase in excitation stress of the magnetorheological fluid 1. When the average particle diameter d2 of the second metal magnetic particle 3 is below the above lower limit value, a surface area of the second metal magnetic particle 3 is reduced, and a sufficient lifting effect may not be obtained even when the second metal magnetic particle 3 performs Brownian motion. In contrast, when the average particle diameter d2 of the second metal magnetic particle 3 exceeds the above upper limit value, Brownian motion of the second metal magnetic particle 3 decreases, and the lifting effect may be reduced.

When a ratio of the average particle diameter d2 μm of the second metal magnetic particle 3 to the average particle diameter d1 μm of the first metal magnetic particle 2 is defined as a particle diameter ratio d2/d1, the particle diameter ratio d2/d1 is preferably 0.002 or more and 0.100 or less, and more preferably 0.010 or more and 0.080 or less. Accordingly, the balance between the average particle diameter d1 and the average particle diameter d2 is satisfactory, and the magnetorheological fluid 1 capable of achieving both high excitation stress and satisfactory dispersibility of the dispersoid can be achieved. When the particle diameter ratio d2/d1 is below the lower limit value or the particle diameter ratio d2/d1 exceeds the upper limit value, the lifting effect by the second metal magnetic particle 3 cannot be sufficiently obtained, and the dispersibility of the dispersoid may decrease or the excitation stress may decrease.

The average particle diameter d1 and d2 of the first metal magnetic particle 2 and the second metal magnetic particle 3 can be obtained from a volume-based particle size distribution with a laser diffraction and dispersion method. Examples of a device that measures the particle size distribution with the laser diffraction and dispersion method include the MT3300 series manufactured by Microtrac, Inc.

In many cases, the obtained particle size distribution is a bimodal distribution including a peak derived from the first metal magnetic particle 2 and a peak derived from the second metal magnetic particle 3. When the obtained particle size distribution is not a bimodal distribution at a glance, the distribution is capable of being decomposed into two peaks by being subjected to fitting processing to two normal distributions whose modes are sufficiently separated (separated by 4 μm or more).

Therefore, the average particle diameters d1 and d2 of the first metal magnetic particle 2 and the second metal magnetic particle 3 are obtained as follows.

First, fitting to processing two normal distributions whose modes are separated by 4 μm or more is performed on the particle size distribution. Next, among the two normal distributions extracted by the fitting processing, a large diameter side is defined as a first normal distribution, and a small diameter side is defined as a second normal distribution, and a particle diameter corresponding to the peak value of each distribution is extracted. A median diameter in the first normal distribution is regarded as the average particle diameter d1 of the first metal magnetic particle 2. A median diameter in the second normal distribution is regarded as the average particle diameter d2 of the second metal magnetic particle 3.

A total content of the first metal magnetic particles 2 and the second metal magnetic particles 3 in the magnetorheological fluid 1 is preferably 40 mass % or more and 95 mass % or less, more preferably 50 mass % or more and 90 mass % or less, and further preferably 60 mass % or more and 85 mass % or less. Accordingly, the viscosity of the magnetorheological fluid 1 can be optimized. The excitation stress in the magnetorheological fluid 1 can be sufficiently increased.

When the content of the first metal magnetic particles 2 is c1 and the content of the second metal magnetic particles 3 is c2, a content mass ratio c2/c1 is preferably 1/150 or more and 1/4 or less (0.007 or more and 0.250 or less), more preferably 1/120 or more and 1/10 or less (0.008 or more and 0.100 or less), and further preferably 1/90 or more and 1/50 or less (0.011 or more and 0.020 or less). By setting the content mass ratio c2/c1 within the above ranges, the magnetorheological fluid 1 capable of achieving both high excitation stress and satisfactory dispersibility of the dispersoid can be achieved. When the mass ratio c2/c1 is below the above lower limit value, the ratio of the content c2 to the content c1 is too low, and therefore the lifting effect by the second metal magnetic particle 3 cannot be sufficiently obtained, and the dispersibility of the dispersoid may decrease. In contrast, when the content mass ratio c2/c1 exceeds the above upper limit value, the ratio of the content c2 to the content c1 becomes too high, and therefore the viscosity of the magnetorheological fluid 1 when no magnetic field is applied may become too high.

The content c2 of the second metal magnetic particles 3 is particularly preferably 0.01 mass % or more and 5 mass % or less, and more preferably 0.1 mass % or more and 3 mass % or less. Accordingly, the magnetorheological fluid 1 capable of achieving both high excitation stress and satisfactory dispersibility of the dispersoid while optimizing the viscosity of the magnetorheological fluid 1 when no magnetic field is applied can be achieved.

A particle shape of each of the first metal magnetic particle 2 and the second metal magnetic particle 3 is not particularly limited, and may be a perfect sphere, an oval sphere, a polyhedron, or other shapes. Examples of other shapes include a needle shape, a fiber shape, a plate shape, a scale shape, and a hollow shape.

The particle shapes of the first metal magnetic particle 2 and the second metal magnetic particle 3 may be the same as or different from each other. The particle shapes of the first metal magnetic particles 2 and the particle shapes of the second metal magnetic particles 3 may also be the same or different from each other.

Various additives may be added to the magnetorheological fluid 1. Examples of the additive include a non-magnetic particle, a detergent, a dispersant, an antioxidant, an anti-wear agent, an extreme pressure agent, a friction modifier, a surfactant, a thixotropy-imparting agent (thickener), and a viscosity-reducing agent, and one or a mixture of two or more of these additives is used.

Examples of the non-magnetic particle include particles made of a non-magnetic inorganic material, a thermoplastic resin, and a thermosetting resin. A content of the non-magnetic particles in the magnetorheological fluid 1 is preferably 0.01 mass % or more and 5 mass % or less, more preferably 0.1 mass % or more and 3 mass % or less, and further preferably 0.5 mass % or more and 2 mass % or less.

Examples of the dispersant include oleates, naphthenates, sulfonates, phosphate esters, stearic acid, stearates, glycerol monooleate, sorbitan sesquioleate, lauric acid, fatty acids, and fatty alcohols.

Examples of the anti-wear agent include organic molybdenum compounds such as molybdenum dialkyldithiocarbamates and molybdenum dialkyldithiophosphates, and organic zinc compounds such as zinc dialkyldithiocarbamates and zinc dialkyldithiophosphates.

A total content of the additive is preferably 10 mass % or less, more preferably 8 mass % or less, and further preferably 6 mass % or less of the entire magnetorheological fluid 1. Accordingly, it is possible to prevent the respective functions of the first metal magnetic particle 2 and the second metal magnetic particle 3 from being hindered by the additive.

### 1.2. Dispersion Medium

The dispersion medium of the magnetorheological fluid 1 includes the ionic liquid 4. The ionic liquid 4 has a cationic group and an anionic group.

### 1.2.1. Cationic Group

The cationic group is selected from the group including a quaternary ammonium ion, an imidazolium ion, a pyridinium ion, and a phosphonium ion.

### 1.2.1.1. Quaternary Ammonium Ion

Examples of the quaternary ammonium ion include a cation represented by the following formula (A). A main structure of the cation is a nitrogen atom.

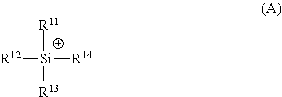

In the formula (A), R¹¹ to R¹⁴ each independently represent a linear or branched alkyl group having 1 or more and 20 or less carbon atoms. R¹¹ to R¹⁴ may be bonded to each other to form a ring.

When R¹¹ to R¹⁴ are each a linear or branched alkyl group, the quaternary ammonium ion is also particularly referred to as an aliphatic quaternary ammonium ion. When R¹¹ to R¹⁴ are bonded to each other to form a ring, the quaternary ammonium ion is particularly referred to as an alicyclic quaternary ammonium ion.

Examples of the linear alkyl group of R¹¹ to R¹⁴ include a linear alkyl group having 1 or more and 20 or less carbon atoms. Specific examples thereof include a methyl group, an ethyl group, a propyl group, a butyl group, a pentyl group, a hexyl group, a heptyl group, an octyl group, a nonyl group, a decanyl group, an undecyl group, a dodecyl group, a tridecyl group, a tetradecyl group, a pentadecyl group, a hexadecyl group, a heptadecyl group, an octadecyl group, a nonadecyl group, and an icosyl group.

Examples of the branched alkyl group of R¹¹ to R¹⁴ include a branched alkyl group having 3 or more and 20 or less carbon atoms. Specific examples thereof include a 1-methylethyl group, a 1-methylpropyl group, a 2-methylpropyl group, a 1-methylbutyl group, a 2-methylbutyl group, a 3-methylbutyl group, a 1-ethylbutyl group, a 2-ethylbutyl group, a 1-methylpentyl group, a 2-methylpentyl group, a 3-methylpentyl group, and a 4-methylpentyl group.

When R¹¹ to R¹⁴ are bonded to each other to form a ring, examples of the formed ring include a cyclopropyl group, a cyclobutyl group, a cyclopentyl group, a cyclohexyl group, a cycloheptyl group, a cyclooctyl group, a cyclodecyl group, and a cyclododecyl group.

Specific examples of the quaternary ammonium ion include tetraethylammonium, tetramethylammonium, tetrapropyl ammonium, tetrabutyl ammonium, and tetrapentyl ammonium.

As the quaternary ammonium ion, a cation represented by the following (A)-1, (A)-2, or (A)-3 is preferable. The ionic liquid 4 having these cations is still a liquid even at −20° C. or lower and is less likely to evaporate even at 350° C. or higher. Therefore, the ionic liquid 4 having these cations contributes to the implementation of the magnetorheological fluid 1 which is particularly highly reliable. (A)-1 represents an aliphatic quaternary ammonium ion, and (A)-2 and (A)-3 represent alicyclic quaternary ammonium ions.

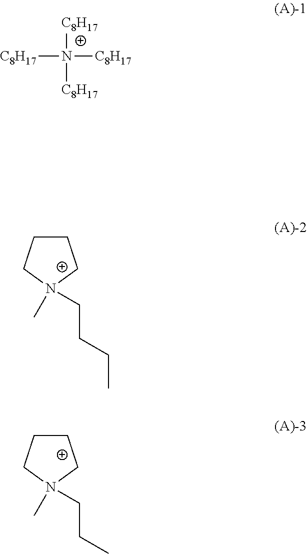

### 1.2.1.2. Imidazolium Ion

Examples of the imidazolium ion include a cation represented by the following formula (B). The main structure of the cation is a 5-membered ring structure composed of a carbon atom and a nitrogen atom.

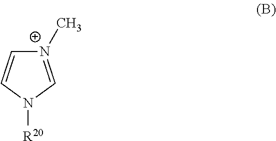

In the formula (B), R²⁰ represents a linear or branched alkyl group having 1 or more and 20 or less carbon atoms.

The description of the alkyl group of R²⁰ in the formula (B) is the same as the description of the alkyl groups of R¹¹ to R¹⁴ in the formula (A).

R²⁰ is preferably an alkyl group having 1 or more and 10 or less carbon atoms, and more preferably an alkyl group having 2 or more and 8 or less carbon atoms.

As the imidazolium ion, a cation represented by the following formula (B)-1 is more preferable. The ionic liquid 4 having this cation is still a liquid even at −20° C. or lower and is less likely to evaporate even at 350° C. or higher. Therefore, the ionic liquid 4 having this cation contributes to the implementation of the magnetorheological fluid 1 which is particularly highly reliable.

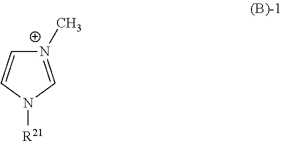

In the formula (B)-1, R²¹ represents an alkyl group having 4 or more and 8 or less carbon atoms.

Examples of R²¹ include an n-butyl group, a sec-butyl group, an isobutyl group, a tert-butyl group, a pentyl group, a hexyl group, a heptyl group, and an octyl group.

### 1.2.1.3. Pyridinium Ion

Examples of the pyridinium ion include a cation represented by the following formula (C). The main structure of the cation is a 6-membered ring structure formed by a carbon atom and a nitrogen atom.

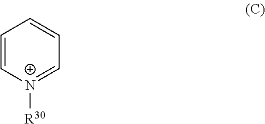

In the formula (C), R³⁰ represents a linear or branched alkyl group having 1 or more and 20 or less carbon atoms.

The description of the alkyl group of R³⁰ in the formula (C) is the same as the description of the alkyl groups of R¹¹ to R¹⁴ in the formula (A).

R³⁰ is preferably an alkyl group having 1 or more and 10 or less carbon atoms, and more preferably an alkyl group having 2 or more and 8 or less carbon atoms.

As the pyridinium ion, a cation represented by the following formula (C)-1 is preferable. The ionic liquid 4 having this cation is still a liquid even at −20° C. or lower and is less likely to evaporate even at 350° C. or higher. Therefore, the ionic liquid 4 having this cation contributes to the implementation of the magnetorheological fluid 1 which is particularly highly reliable.

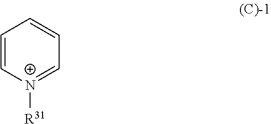

In the formula (C)-1, R³¹ represents an alkyl group having 4 or more and 6 or less carbon atoms.

Examples of R³¹ include an n-butyl group, a sec-butyl group, an isobutyl group, a tert-butyl group, a pentyl group, and a hexyl group.

### 1.2.1.4. Phosphonium Ion

Examples of the phosphonium ion include a cation represented by the following formula (D). The main structure of the cation is a phosphorus atom.

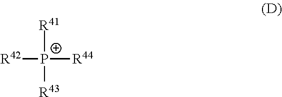

In the formula (D), R⁴¹ to R⁴⁴ each independently represent a linear or branched alkyl group having 1 or more and 20 or less carbon atoms. R⁴¹ to R⁴⁴ may be bonded to each other to form a ring.

The description of the alkyl groups of R⁴¹ to R⁴⁴ in the formula (D) is the same as the description of the alkyl groups of R¹¹ to R¹⁴ in the formula (A).

R⁴¹ to R⁴⁴ are each preferably an alkyl group having 2 or more and 18 or less carbon atoms, and more preferably an alkyl group having 4 or more and 16 or less carbon atoms.

Specific examples of the phosphonium ion include tetrabutylphosphonium, tetrapropylphosphonium, tetraethylphosphonium, tetramethylphosphonium, and hexadecyltributylphosphonium.

As the phosphonium ion, a cation represented by the following formula (D)-1 is preferable. The ionic liquid 4 having this cation is still a liquid even at −20° C. or lower and is less likely to evaporate even at 350° C. or higher. Therefore, the ionic liquid 4 having this cation contributes to the implementation of the magnetorheological fluid 1 which is particularly highly reliable.

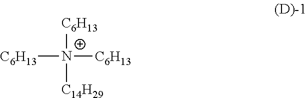

### 1.2.2. Anionic Group

The anionic group is selected from the group including a tetrafluoroborate ion, a hexafluorophosphate ion, a trispentafluoroethyl trifluorophosphate ion, and a bis(trifluoromethanesulfonyl)amide ion.

All of the listed cations and the listed anions are bulky ions. Therefore, by using the ions listed as the cationic group and the anionic group provided in the ionic liquid 4, the ionic liquid 4 capable of satisfactorily dispersing the dispersoid even at a low temperature or a high temperature can be achieved. That is, such an ionic liquid 4 is still a liquid even at a low temperature of 0° C. or lower and is less likely to evaporate even at a high temperature of 250° C. or higher, and thus is a dispersion medium having high reliability. Since the ionic liquid 4 has affinity with the first metal magnetic particles 2 and the second metal magnetic particles 3 higher than those in the mineral oil, the separation of the dispersoid and the dispersion medium is less likely to occur by using the ionic liquid 4 as the dispersion medium. As a result, the magnetorheological fluid 1 that maintains satisfactory dispersibility of the dispersion medium and exhibits high excitation stress regardless of the environment can be achieved.

The dispersion medium is preferably formed of the ionic liquid 4, but the dispersion medium may contain an additive other than the ionic liquid 4 as long as the effect of the ionic liquid 4 is not impaired. Examples of such an additive include a thixotropic agent, a surfactant, a plastic medium, and a water-in-oil emulsion.

A content of the ionic liquid 4 in the magnetorheological fluid 1 is preferably 5 mass % or more and 60 mass % or less, more preferably 10 mass % or more and 50 mass % or less, and further preferably 10 mass % or more and 30 mass % or less. Accordingly, the dispersed state of the dispersoids can be satisfactorily maintained. In addition, the viscosity of the magnetorheological fluid 1 can be optimized.

### 1.3. Physical Properties of Magnetorheological Fluid

The excitation stress of the magnetorheological fluid 1 can be evaluated as a yield stress when a magnetic field having a magnetic flux density of 1.0 T is applied. The excitation stress is preferably 15 kPa or more and more preferably 20 kPa or more at a temperature of 250° C. Accordingly, the magnetorheological fluid 1 exhibiting sufficient excitation stress is obtained. Such a magnetorheological fluid 1 is useful in various applications.

The excitation stress of the magnetorheological fluid 1 is measured as follows.

First, a magnetic field having a magnetic flux density of 1.0 T is applied to the magnetorheological fluid 1 at a predetermined temperature. Next, in this state, a shear rate of 333/s is applied to measure a shear stress. To measure the shear stress, for example, a rheometer MCR102 manufactured by Anton Paar can be used. Then, the measured shear stress is used as the yield stress.

A boiling point of the magnetorheological fluid 1 is preferably 250° C. or higher, more preferably 300° C. or higher, and further preferably 350° C. or higher. Accordingly, the magnetorheological fluid 1 having sufficient heat resistance is obtained.

The boiling point of the magnetorheological fluid 1 is measured as follows.

First, 2 mL of the magnetorheological fluid 1 is heated by a hot plate. Next, the temperature of the magnetorheological fluid 1 when white smoke is generated is measured, and the measurement value is taken as the boiling point.

A freezing point of the magnetorheological fluid 1 is preferably 0° C. or lower, more preferably −10° C. or lower, and further more preferably −20° C. or lower. Accordingly, the magnetorheological fluid 1 having sufficient cold resistance is obtained.

The freezing point of the magnetorheological fluid 1 is measured as follows.

First, 2 mL of the magnetorheological fluid 1 is cooled by a refrigerator. Next, the temperature at which the magnetorheological fluid 1 is solidified is measured, and the measurement value is taken as the freezing point.

### 1.4. Application Examples of Magnetorheological Fluid

Examples of applications of the magnetorheological fluid 1 include various apparatuses or devices utilizing a difference in excitation stress that occurs when the application of a magnetic field is switched. Examples of such an apparatus or a device include a vibration control device such as a linear damper, a rotary damper, or a shock absorber, a braking device such as a brake, a power transmission device such as a clutch, a muscle part or an end effector of a robot, a valve for controlling a liquid flow rate, a tactile presentation device, an acoustic device, a medical and welfare robot hand, a nursing hand, and personal mobility.

### 1.5. Method for Producing Magnetorheological Fluid

In a method for producing the magnetorheological fluid 1, first, raw materials of the above-described magnetorheological fluid 1 are mixed and stirred. Examples of a stirring method include stirring with a spatula, a vortex mixer, a high shear mixer, and a low-frequency acoustic resonance mixer. The stirring time is appropriately set according to the stirring method and is preferably 5 minutes or more and 4 hours or less. The stirring temperature is appropriately set according to the stirring method and is preferably 15° C. or higher and 70° C. or lower.

### 2. Braking Device

Next, a braking device according to the embodiment will be described.

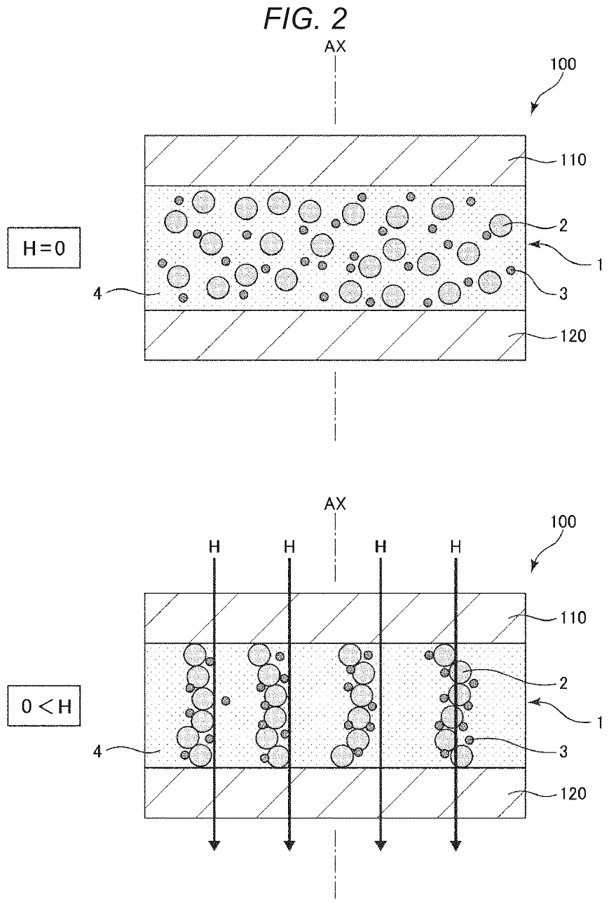

FIG. 2 is a longitudinal cross-sectional view illustrating a braking device 100 according to the embodiment.

The braking device 100 illustrated in FIG. 2 includes a fixed disk 110 (a fixed portion), a movable disk 120 (a movable portion), and the magnetorheological fluid 1. The movable disk 120 is rotatable (movable) about a rotation axis AX with respect to the fixed disk 110. The magnetorheological fluid 1 is held between the fixed disk 110 and the movable disk 120. The braking device 100 includes a magnetic field generation unit (not illustrated). The magnetic field generation unit applies a magnetic field to the magnetorheological fluid 1.

In the braking device 100, the excitation stress of the magnetorheological fluid can be changed by switching the magnetic field applied to the magnetorheological fluid 1. Accordingly, a resistance force to rotation of the movable disk 120 with respect to the fixed disk 110 can be changed. As a result, the braking device 100 uses the resistance force as a brake force to brake a vehicle or the like.

The fixed disk 110 is coupled to, for example, a vehicle body side of the automobile, and the movable disk 120 is coupled to, for example, a wheel side of the automobile.

When a magnetic field H is not applied to the magnetorheological fluid 1 (H=0), the first metal magnetic particles 2 and the second metal magnetic particles 3 are in the dispersed state in the magnetorheological fluid 1. In this case, the excitation stress of the magnetorheological fluid 1 is sufficiently small, and almost no brake force is generated.

When the magnetic field H is applied to the magnetorheological fluid 1 (0<H), in the magnetorheological fluid 1, the first metal magnetic particles 2 and the second metal magnetic particles 3 form a cluster structure. In this case, the excitation stress of the magnetorheological fluid 1 increases, and the brake force is generated.

The magnetorheological fluid 1 according to the embodiment described above can achieve both high reliability and high excitation stress even when being used at a low temperature or a high temperature. Therefore, the braking device 100 according to the embodiment has high reliability without causing a decrease in brake force even in a severe environment.

The configuration of the braking device 100 is not limited to thereto. For example, the braking device of the present disclosure may include three or more disks.

### 3. Effects of Embodiment

As described above, the magnetorheological fluid 1 according to the above embodiment includes the first metal magnetic particles 2, the second metal magnetic particles 3, and the ionic liquid 4. The first metal magnetic particle 2 has the average particle diameter d1 of 5 μm or more. The second metal magnetic particle 3 has the average particle diameter d2 of 500 nm or less. The ionic liquid 4 has the cationic group and the anionic group.

The cationic group is one or more selected from the group including a quaternary ammonium ion, an imidazolium ion, a pyridinium ion, and a phosphonium ion.

The anionic group is one or more selected from the group including a tetrafluoroborate ion, a hexafluorophosphate ion, a trispentafluoroethyl trifluorophosphate ion, and a bis(trifluoromethanesulfonyl)amide ion.

According to such a configuration, the magnetorheological fluid 1 capable of achieving both high reliability and high excitation stress can be obtained even when being used at a low temperature or a high temperature.

In the magnetorheological fluid 1 according to the above embodiment, the cationic group may have a cation represented by the following formula (A)-1, (A)-2, (B)-1, (C)-1, or (D)-1.

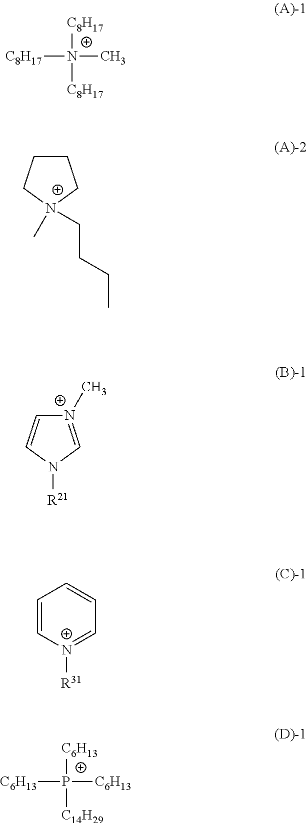

According to such a configuration, the magnetorheological fluid 1 can be obtained with particularly high reliability since it remains liquid even at lower temperatures and is less likely to evaporate even at higher temperatures.

In the magnetorheological fluid 1 according to the above embodiment, the average particle diameter d2 of the second metal magnetic particle 3 is preferably 15 nm or more and 50 nm or less.

According to such a configuration, the lifting effect by the Brownian motion of the second metal magnetic particles 3 can be more sufficiently obtained. According to such a configuration, the second metal magnetic particles 3 contribute to a further increase in excitation stress of the magnetorheological fluid 1.

In the magnetorheological fluid 1 according to the above embodiment, the content of the second metal magnetic particles 3 is preferably 0.01 mass % or more and 5 mass % or less.

According to such a configuration, the magnetorheological fluid 1 capable of achieving both high excitation stress and satisfactory dispersibility of the dispersoid while optimizing the viscosity of the magnetorheological fluid 1 when no magnetic field is applied can be achieved.

In the magnetorheological fluid 1 according to the above embodiment, when the content of the first metal magnetic particles 2 is c1 and the content of the second metal magnetic particles 3 is c2, the content mass ratio c2/c1 is preferably 1/150 or more and 1/4 or less.

According to such a configuration, the magnetorheological fluid 1 capable of achieving both high excitation stress and satisfactory dispersibility of the dispersoid can be achieved.

In the magnetorheological fluid 1 according to the above embodiment, when the average particle diameter of the first metal magnetic particle 2 is d1 μm and the average particle diameter of the second metal magnetic particle 3 is d2 μm, the particle diameter ratio d2/d1 is preferably 0.002 or more and 0.100 or less.

According to such a configuration, the magnetorheological fluid 1 capable of achieving both high excitation stress and satisfactory dispersibility of the dispersoid can be achieved.

In the magnetorheological fluid 1 according to the above embodiment, at least one of the material forming the first metal magnetic particle 2 and the material forming the second metal magnetic particle 3 may be an amorphous metal material or a microcrystalline metal material.

According to such a configuration, these materials contribute to sufficient lowering of the coercive force of the first metal magnetic particle 2 and the second metal magnetic particle 3 and enhancement of the redispersibility. These materials have toughness and strength higher than, for example, those of metal oxides. Therefore, the first metal magnetic particle 2 and the second metal magnetic particle 3 can be effectively prevented from being worn or damaged.

The braking device 100 according to the above embodiment includes the fixed disk 110 (a fixed portion), the movable disk 120 (a movable portion), the magnetorheological fluid 1 according to the above embodiment, and a magnetic field generation unit. The movable disk 120 is movable with respect to the fixed disk 110. The magnetorheological fluid 1 is held between the fixed disk 110 and the movable disk 120. The magnetic field generation unit applies a magnetic field to the magnetorheological fluid 1.

According to such a configuration, the braking device 100 having high reliability without causing a decrease in brake force even in a severe environment can be achieved.

As described above, the magnetorheological fluid and the braking device according to the present disclosure have been described based on the preferred embodiment, but the present disclosure is not limited thereto.

For example, the magnetorheological fluid and the braking device according to the present disclosure may be obtained by adding any configuration to the above embodiment. The configuration of each part of the braking device according to the above embodiment may be replaced with a configuration having the same function as described above.

### EXAMPLES

Next, specific examples of the present disclosure will be described.

### 4. Preparation of Magnetorheological Fluid

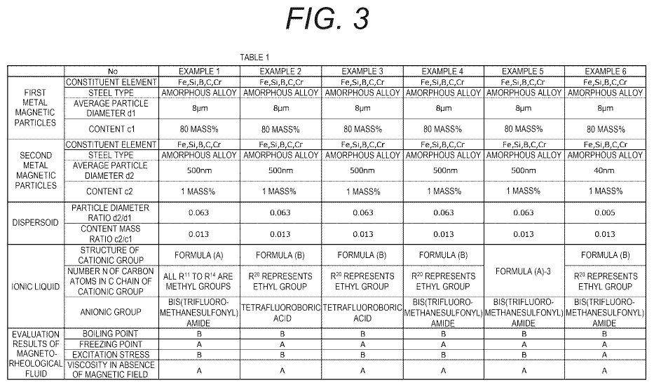

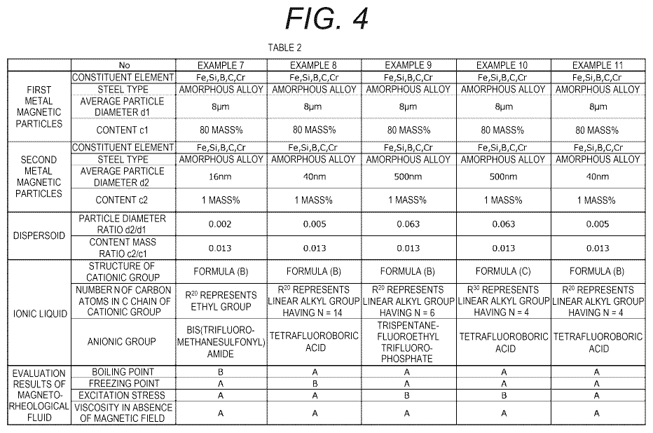

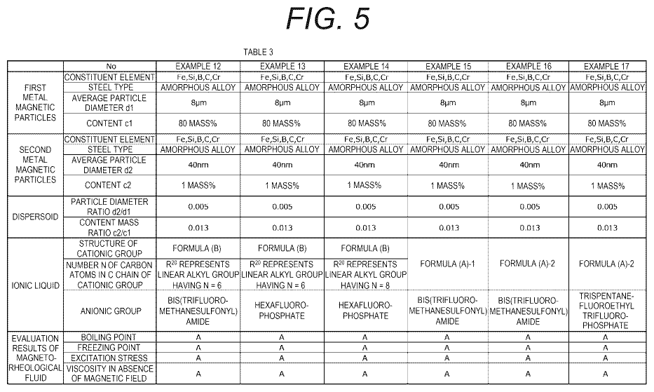

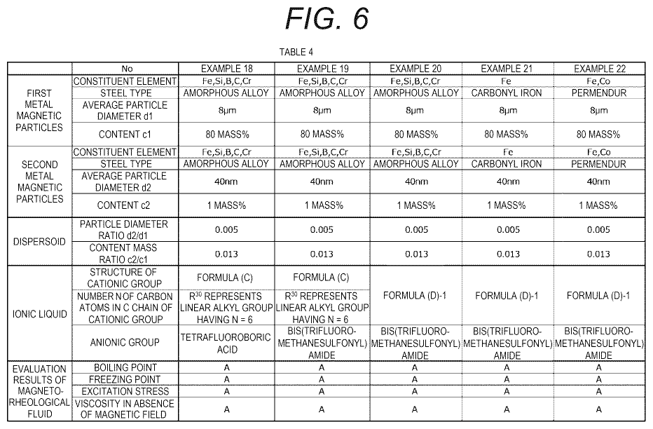

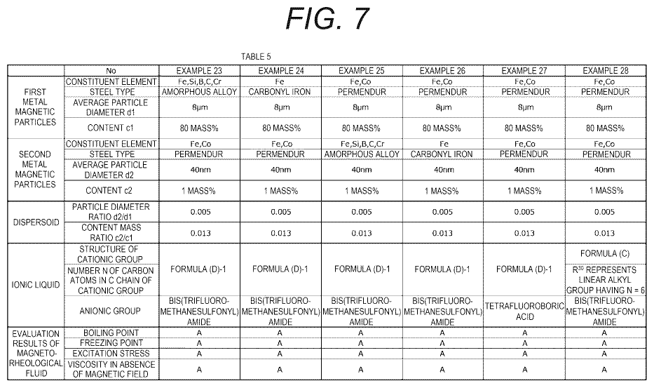

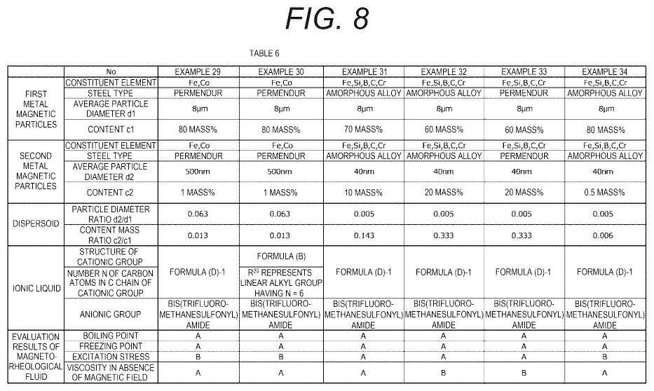

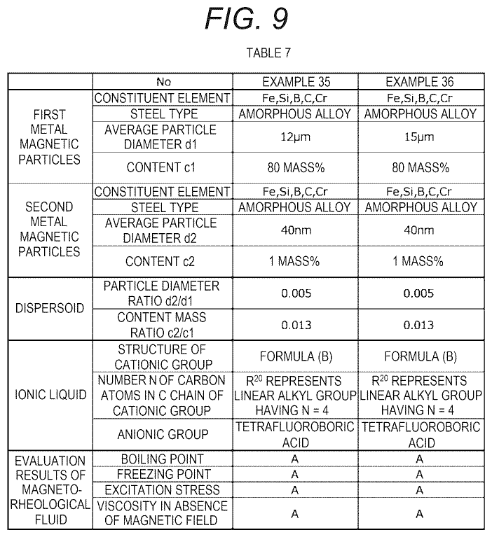

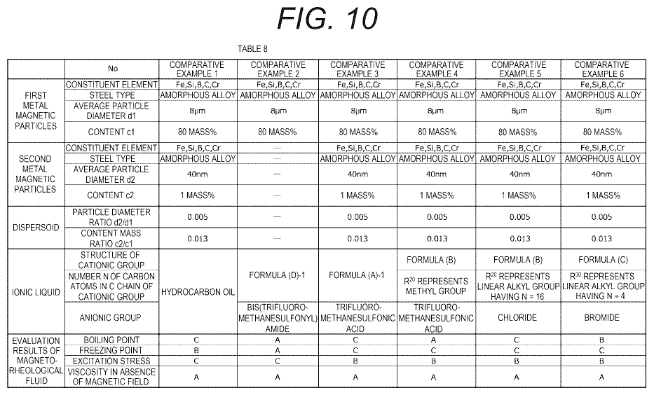

FIGS. 3 to 11 are Tables 1 to 9 indicating preparation conditions and evaluation results of the magnetorheological fluid.

The magnetorheological fluid was prepared as follows.

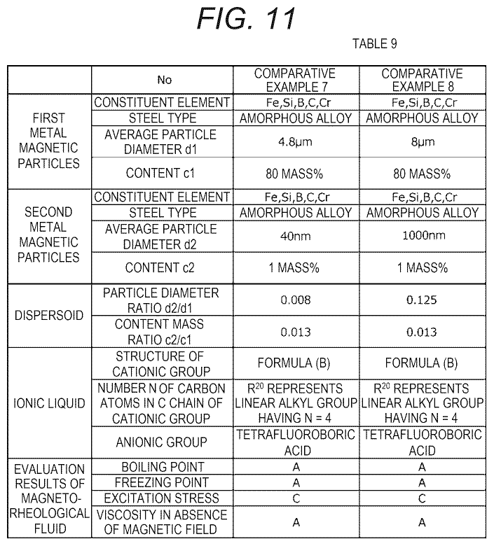

First, the first metal magnetic particles, the second metal magnetic particles, and the ionic liquid illustrated in Table 1 (FIG. 3) to Table 9 (FIG. 11) were mixed. The contents of the first metal magnetic particles and the second metal magnetic particles are as indicated in Tables 1 to 9. The remainder of the content was the ionic liquid. Next, the obtained mixture was stirred. A high shear mixer (Silverson, L5M-A) was used as a stirring device. The stirring conditions were a rotation speed of 3000 rpm and a stirring time of 30 minutes. Accordingly, the magnetorheological fluids of Examples 1 to 36 and Comparative Examples 1 to 8 were prepared.

The “C chain of cationic group” in Tables 1 to 9 indicates an alkyl group having the largest number of carbon atoms bonded to the main structure of the cationic group.

### 5. Evaluation of Magnetorheological Fluid

The boiling point, the freezing point, the excitation stress, and the viscosity in the absence of a magnetic field were evaluated for each magnetorheological fluid of the examples and comparative examples.

### 5.1. Boiling Point

The boiling point of each magnetorheological fluid of the examples and comparative examples was evaluated by the above method. Then, the measured boiling point was evaluated against the following evaluation criteria. The evaluation results are indicated in Tables 1 to 9. Among the evaluation criteria, when the evaluation result is A or B, it can be evaluated that “the boiling point of the magnetorheological fluid is high (heat resistance is satisfactory)”.
A: The boiling point is 350° C. or higher.
B: The boiling point is 250° C. or higher and less than 350° C.
C: The boiling point is less than 250° C.

### 5.2. Freezing Point

The freezing point of each magnetorheological fluid of the examples and comparative examples was evaluated by the above method. Then, the measured freezing point was evaluated against the following evaluation criteria. The evaluation results are indicated in Tables 1 to 9. Among the evaluation criteria, when the evaluation result is A or B, it can be evaluated that “the freezing point of the magnetorheological fluid is low (cold resistance is satisfactory)”.
A: The freezing point is −20° C. or lower.
B: The freezing point is higher than −20° C. and 0° C. or lower.
C: The freezing point is higher than 0° C.

### 5.3. Excitation Stress

The excitation stress of each magnetorheological fluid of the examples and comparative examples was evaluated by the above method. Then, the measured excitation stress was evaluated in view of the following evaluation criteria. The evaluation results are indicated in Tables 1 to 9. Among the evaluation criteria, when the evaluation result is A or B, it can be evaluated that “the excitation stress of the magnetorheological fluid is high”.
A: The excitation stress is 20 kPa or more.
B: The excitation stress is 15 kPa or more and less than 20 kPa.
C: The excitation stress is less than 15 kPa.

### 5.4. Viscosity in Absence of Magnetic Field

The viscosity of the magnetorheological fluid of each of examples and comparative examples was measured at a non-magnetic field (at a magnetic flux density of 0 T). To measure the viscosity, a rheometer MCR102 manufactured by Anton Paar was used. The shear rate during measurement was 0.033/s, and the temperature of the magnetorheological fluid during the measurement was 25° C. Then, the measured viscosity was evaluated against the following evaluation criteria. The evaluation results are indicated as “viscosity in absence of magnetic field” in Tables 1 to 9. Among the evaluation criteria, when the evaluation result is A, it can be evaluated that “the viscosity in absence of magnetic field of the magnetorheological fluid is satisfactory”.
A: The viscosity is less than 1000 mPa·S.
B: The viscosity is 1000 mPa·s or more.

As is clear from Tables 1 to 9, each of the evaluation results of the boiling point, the freezing point, and the excitation stress in each magnetorheological fluid of the examples was A or B, which was a satisfactory result.

In contrast, in the magnetorheological fluid of Comparative Example 1 in which the ionic liquid was not used as the dispersion medium, the evaluation results of the boiling point and the excitation stress were poor.

In the magnetorheological fluid of Comparative Example 2 in which the second metal magnetic particles were not provided, the evaluation result of the excitation stress was poor.

In the magnetorheological fluids of Comparative Examples 3 to 6 using an ionic liquid as the dispersion medium but not including a specific ion, the boiling point or the freezing point was poor.

In addition, in the magnetorheological fluids of Comparative Examples 7 and 8 in which the average particle diameter d1 of the first metal magnetic particle or the average particle diameter d2 of the second metal magnetic particle was out of a predetermined range, the evaluation result of the excitation stress was poor.

From the above results, according to the present disclosure, it is possible to achieve a magnetorheological fluid capable of achieving both high reliability and high excitation stress even when being used at a low temperature or a high temperature.

What is claimed is:

1. A magnetorheological fluid comprising:
a first metal magnetic particle having an average particle diameter of 5 μm or more;
a second metal magnetic particle having an average particle diameter of 500 nm or less; and
an ionic liquid having a cationic group and an anionic group, wherein
the cationic group is one or more selected from the group including a quaternary ammonium ion, an imidazolium ion, a pyridinium ion, and a phosphonium ion, and
the anionic group is one or more selected from the group including a tetrafluoroborate ion, a hexafluorophosphate ion, a trispentafluoroethyl trifluorophosphate ion, and a bis(trifluoromethanesulfonyl)amide ion.

2. The magnetorheological fluid according to claim 1, wherein
the cationic group has a cation represented by the following formula (A)-1, (A)-2, (B)-1, (C)-1, or (D)-1.

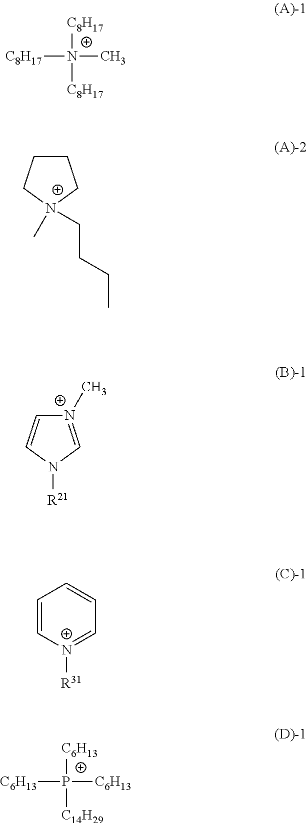

3. The magnetorheological fluid according to claim 1, wherein
the average particle diameter of the second metal magnetic particle is 15 nm or more and 50 nm or less.

4. The magnetorheological fluid according to claim 1, wherein
a content of the second metal magnetic particle is 0.01 mass % or more and 5 mass % or less.

5. The magnetorheological fluid according to claim 1, wherein
when a content of the first metal magnetic particle is c1 and a content of the second metal magnetic particle is c2, a content mass ratio c2/c1 is 1/150 or more and 1/4 or less.

6. The magnetorheological fluid according to claim 1, wherein
when the average particle diameter of the first metal magnetic particle is d1 μm and the average particle diameter of the second metal magnetic particle is d2 μm, a particle diameter ratio d2/d1 is 0.002 or more and 0.100 or less.

7. The magnetorheological fluid according to claim 1, wherein
at least one of a material forming the first metal magnetic particle and a material forming the second metal magnetic particle is an amorphous metal material or a microcrystalline metal material.

8. A braking device comprising
a fixed portion;
a movable portion movable with respect to the fixed portion;
the magnetorheological fluid according to claim 1 held between the fixed portion and the movable portion; and
a magnetic field generation unit configured to apply a magnetic field to the magnetorheological fluid.
